(19) United States
(12) Patent Application Publication
(10) Pub. No.: US 2009/0265427 A1
(43) Pub. Date: Oct. 22, 2009

(54) System and method to create and find online communities

(76) Inventor: Konda Ankireddyapalli, Milpitas, CA (US)

Correspondence Address: SCHEIN & CAI LLP;James Cai, 111 W. ST. JOHN ST., SUITE 1250, SAN JOSE, CA, 95113, US

(21) Appl. No.: 12/148,502

(22) Filed: Apr. 21, 2008

(51) Int. Cl. G06F 15/16

(52) U.S. Cl. 709/204

(57) ABSTRACT

A method and system are directed towards defining user Communities based on prospective member's eligibility criteria. Community eligibility profiles of the Communities in a collective set of Communities are applied towards prospective member's (user) profile information. The system allows users to create their own Communities by entering a Community eligibility profile to match other users of the system and notify the prospective members (other users) of the new Community.

### BACKGROUND OF THE INVENTION

I. Field

This invention relates generally to e-businesses and, more specifically, to system and method for creating and finding online communities for association.

II. Background

In recent years online communities have grown in both numbers and popularity. Driving this growth are the expanding internet, necessity of being connected to more and more people and finally the technologies like Yahoo groups, Google groups, etc. This rapid growth is creating new problems. First and foremost users need to spend more time and effort in finding the communities which may provide information of interest to them.

Thus, there is a need for a system that allows users to enter their user profile that may be matched to Community eligibility profiles associated with a plurality of communities and notify the user of any matches.

### SUMMARY

A method and system for defining eligibility criteria for communities and informing users of the system whenever they match or meet the criteria.

The present invention includes a system comprising: at least one server operable to establish a community eligibility profile for one or more Communities and receive a user profile from each user; at least one database coupled to the at least one server to store a Community eligibility profile for the one or more Communities and the user profile of one or more users; and the at least one server is further operable to determine which of the user profiles meet the Community eligibility profile of one or more Communities and to notify the one or more users of any matched Communities with an option to join any of the matched Communities.

The present invention provides a computer program product including a computer readable medium having instructions for causing a computer to: receive a user profile from each user; receive a user generated community eligibility profile for a Community; store the Community eligibility profile for one or more Communities; store the user profile of one or more users; determine which of the user profiles meet the Community eligibility profile of one or more Communities; and notify the one or more users of any matched Communities with an option to join any of the matched Communities.

In addition to the above objects and features, additional objects, features and advantages will become apparent in view of the specification, drawings and appended claims.

### BRIEF DESCRIPTION OF THE DRAWINGS

FIG. 1 illustrates a block diagram of a network in accordance with one embodiment of the present invention.

FIG. 2A illustrates a flowchart of a process to register with the website in accordance with one embodiment of the present invention.

FIG. 2B illustrates a flowchart of a process to enter a user profile in accordance with one embodiment of the present invention.

FIG. 2C illustrates a flowchart of a process to create a new Community in accordance with one embodiment of the present invention.

FIG. 2D illustrates a flowchart of the process to match (meet) and selectively link users to Communities in accordance with one embodiment of the present invention.

FIG. 3 illustrates a block diagram of linked users and communities in accordance with one embodiment of the present invention.

FIG. 4 illustrates an Aspects graphical user interface (GUI) to select and enter Aspects associated with a user for a user profile in accordance with one embodiment of the present invention.

FIG. 5 illustrates an Attributes graphical user interface (GUI) to enter attributes associated with a user selected Aspect in accordance with one embodiment of the present invention.

FIG. 6 illustrates a Create Community graphical user interface (GUI) to create a Community in accordance with one embodiment of the present invention.

FIG. 7 illustrates a flowchart of a process to match users to Communities in accordance with one embodiment of the present invention.

FIG. 8 illustrates a Communities graphical user interface (GUI) in accordance with one embodiment of the present invention.

FIG. 9 illustrates a join Communities graphical user interface (GUI) in accordance with one embodiment of the present invention.

### DETAILED DESCRIPTION

The present invention now will be described more fully hereinafter which reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware pieces. The following description is, therefore, not to be taken in a limiting sense.

An Aspect refers to anything that a user has any associationship. An Aspect could be an object, a person, a place, a relationship, an interest etc. Examples of Aspects include, but not limited to a spouse, home, place of birth, employer, business, video game, game console, audio CD, blu-ray video disk, date, father, brother, cousin, Auto, TV, Laptop, Cell phone, TV Show, friend, shopping complex, artist, politician, god, religion, disease, music band, event, vacation, etc. An Aspect has one or more Attributes.

An Attribute refers to a refined classification of an Aspect and may have an Attribute value or sub-classification. For example, an Auto Aspect can have ‘Make’ as an Attribute. A Friend Aspect can have ‘Name’, ‘Date of birth’, etc. as attributes. The Attribute value may include a sub-classification of the attributes. For example, the Attribute ‘Make’ may have a plurality of possible Attributes. For example, User A may set an Auto's Make attribute to ‘Acura’ or some other make of an automobile. Thus, for comparisons the attribute value Acura would be used for a matching criterion.

A User profile refers to a collection of Aspects and related Attributes specific to a user and a user's account. The user profile may include various user information such as, but not limited to, users personal information, interests, hobbies and other Aspects. Personal information may include birth place, user address, employer, employer address, school address, number of children, number of siblings, etc.

A Community eligibility profile refers to a collection of Aspects and related Attributes specific to a Community that may be used to match users. A Community may be similar to a fan club, a card player's club, a social group, alumni group, etc.

A database refers to a collection of data and may also represent a file.

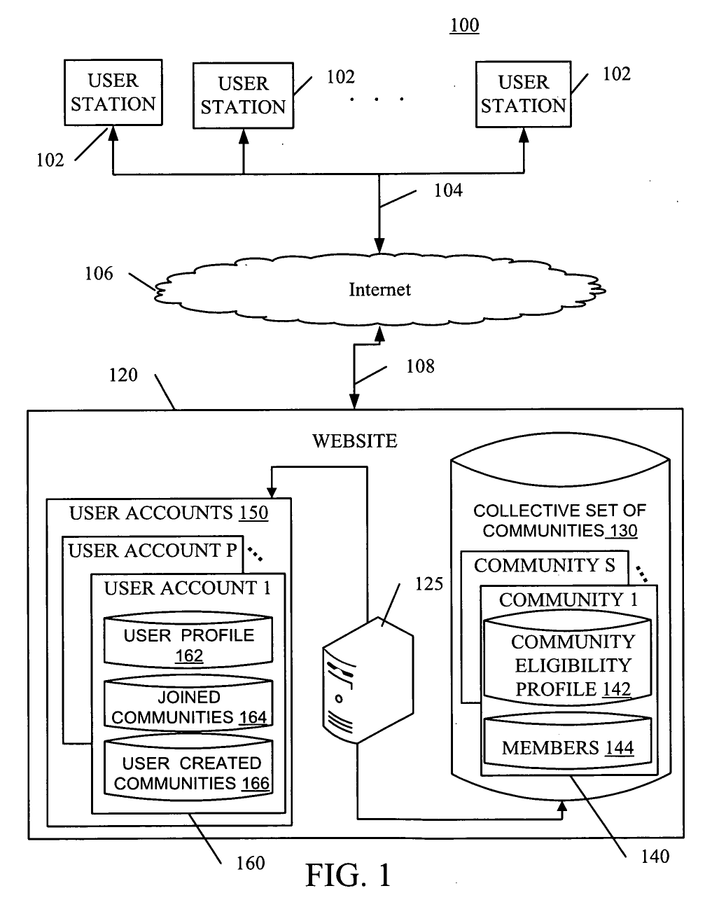

FIG. 1 illustrates is a block diagram of an exemplary network 100 in accordance with one embodiment of the present invention. The network 100 comprises a plurality of client stations 102 in communication via communication path 104 to the Internet 106. Nevertheless some other type of network may be use. Each client station 102 serves as an end user device with either software or firmware capable of exchanging information over the internet 106 or other network using an internet protocol or other network protocols. The internet 106 may include or be in communication with a wireless access network (WAN), a local area network (LAN) or a Metropolitan access network. The network 100 further comprises at least one website system 120 having one or more web servers 125 in communication with the internet 106 via communication path 108.

For example, the one or more web servers 125 may include a host web server, a database server, etc. The website system 120 further includes a collective set of Communities database 130, and a user account database 150. The user account database 150 may include a plurality of user accounts 160. Each user account 160 may include one or more of a user profile database 162, joined (linked) communities database 164, and a user created communities database 166. Each Community 140 may include a community eligibility profile database 142 and a members database 144. There are a plurality of Communities 1-S in the collective set.

The plurality of client stations 102 may include virtually any computing device that can communicate with other computing devices such as web server(s) 125 or the like. The plurality of client stations 102 may include devices that typically connect using a wired communications medium such as personal computers, multiprocessor systems, microprocessor-based or programmable consumer electronics, network PCs, and the like. The plurality client stations 102 may also include devices that typically connect using a wireless communications medium such as cell phones, smart phones, radio frequency communication devices, infrared communication devices, integrated devices combining one or more of the preceding devices or virtually any mobile communication devices, or the like. Similarly the plurality of client stations 102 may be any device that is capable of connecting using a wired or wireless communication medium such as a PDA, Pocket PC, wearable computer, and any other device that is equipped to communicate over a wired or wireless communication medium.

Each of the client stations 102 may include a browser application or non-browser application that is capable of participating in browser protocols and configured to receive and send web pages, messages and the like. The browser application or the non-browser application may be configured to receive and display graphics, text, multimedia, and the like, employing virtually any web based language, including, but not limited to Standard Generalized Markup Language (SMGL), such as Hyper Text Markup Language (HTML), a wireless application protocol (WAP), a Handheld Device Markup Language, such as Wireless Markup Language, WMLScript, JavaScript, and the like. The plurality of client stations 102 may be further configured to receive a message from another computing device employing another mechanism, including, but not limited to email, Short Message Service, Multimedia Message Service, Instant Messaging, Internet Relay Chat, mIRC, Jabber, and the like.

The internet 106 is configured to couple any of the user stations 102 to the website system 108 and enable them to communicate. Also, internet 106 may include a wireless interface, and/or a wired interface, such as the internet, in addition to local area networks, wide area networks, direct connections, such as through a universal serial bus port, other forms of computer readable media, or any combination thereof. On an interconnected set of Local Area Networks, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks, Digital Subscriber Lines, wireless links including satellite links, or other communication links known to those skilled in art. Furthermore remote computers and other related electronic devices could be remotely connected to either LANs or WANs via a modem and temporary telephone link. In essence, internet 106 includes any communication method by which information may travel between client stations 102 and web server 125.

The method used to transmit information in communication links as described above illustrated one type of computer-readable media, namely communication media. Generally, computer readable media includes any media that can be accessed by a computing device to read and execute a set of instructions. Computer readable media may include computer storage media, communication media, or any combination thereof.

Additionally, communication media typically embodies computer-readable instructions, data structures, program modules, or other data in a modulated data signal such as a carrier wave, data signal, or other transport mechanism and includes any information delivery media. The terms ‘modulated data signal’, and ‘carrier wave signal’ includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

The web server(s) 125 may include any computing device capable of connecting to internet 106 such as personal computers desktop computers, multiprocessor systems, microprocessor based or programmable consumer electronics, network PCs, server and the like. The web serve(s) 125 contains at least one processing unit, video display adapter and a mass memory all in communication with each other. The mass memory generally includes RAM, ROM and one or more permanent mass storage devices, such as hard disk drives, tape drives, optical derives, and/or floppy disk drive. The mass memory stores operating system for controlling the operation of web server(s) 125. Any general-purpose operating system may be employed. The web server(s) 125 also can communicate with the internet 106, or some other communications network, via a network interface unit, which is constructed for use with various communications protocols including the TCP/IP protocol. The network interface unit is sometimes known as a transceiver, transceiving device, network interface card and the like.

The mass memory as described above illustrates another type of computer capable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device. The mass memory also stores program code and data. One or more applications are loaded into mass memory and run on the operating system. Examples of application programs include email programs, schedulers, calendars, web services, transcoders, database programs, word processing programs, spreadsheet programs, and so forth.

The collective set of Communities database 130 and a user account database 150 may be stored in one or more computer storage media. The user profile database 162, joined (linked) Communities database 164 and a user created Communities database 166 may be stored in one or more computer storage media. The Community eligibility profile database 142 and a members database 144 may be stored in one or more computer storage media.

The steps or blocks or portions of the flowcharts described below may be performed contemporaneously, in parallel, or in a different order. Moreover one or more of steps may be omitted.

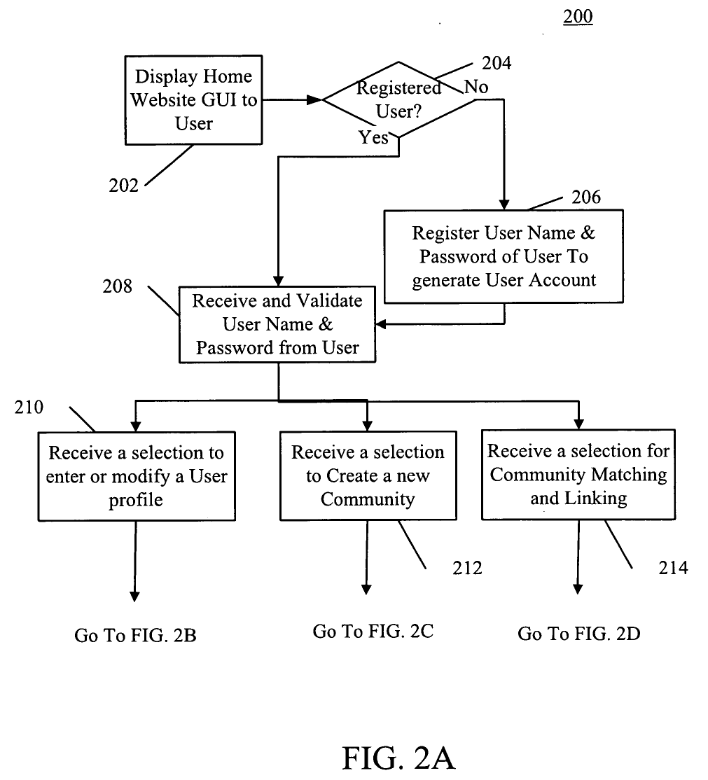

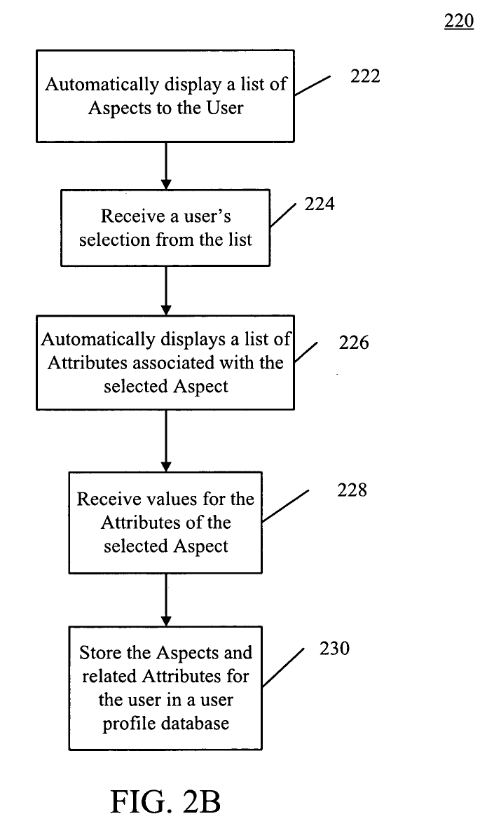

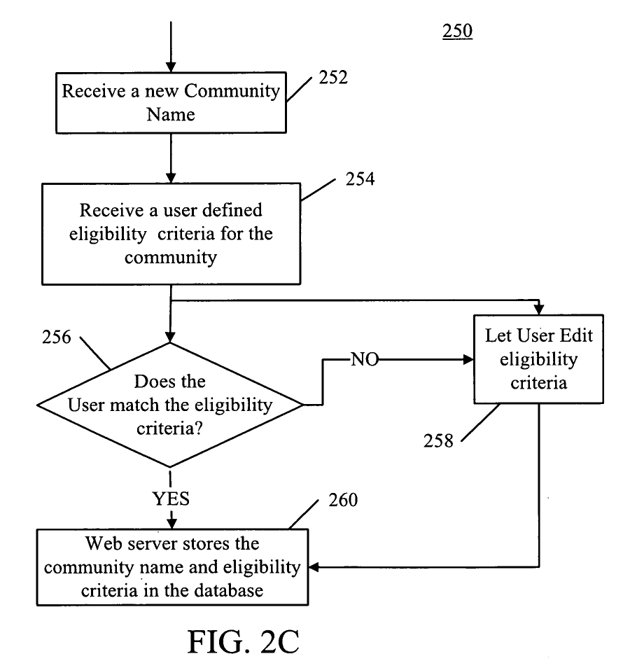

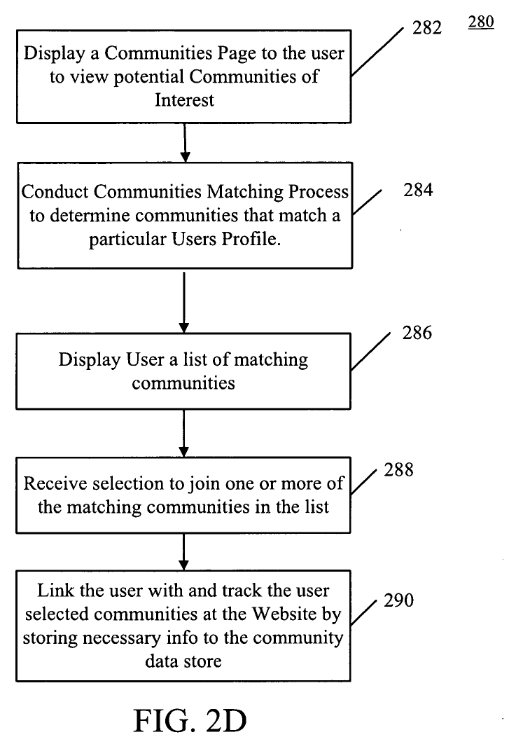

FIG. 2A illustrates a flowchart of a process 200 to register into the website system 120. The process 200 begins with block 202 where the user is displayed a homepage graphical user interface (not shown) so as to log into a user's account or setup a new user account 160. At block 204 a determination is made whether the user is registered. If the determination is “NO,” the user is prompted to register a user name and password at block 206. This step sets-up a respective one User Account 160 of the plurality of User Accounts 1-P. If the determination is “YES,” at block 204, or after block 206, the website system 120 would receive and validate the user name and password from a user. Upon validation, the user is able to enter a user profile or add an Aspect/Attribute to an existing user profile at block 210. If the user selects to enter a user profile or add an Aspect/Attribute to an existing user profile, then the process 200 proceeds to FIG. 2B.

Alternately, the user may select to create or start a new Community at block 212. If the user selects to create a new Community at block 212, then the process 200 proceeds to FIG. 2C. On the other hand, the user may select to perform Community matching and/or linking at block 214. If the user selects to perform Community matching and/or linking then block 214 proceeds to FIG. 2D.

Blocks 210, 212 and 214 are shown in parallel to denote that any one function associated with the blocks 210, 212 and 214 may be selected once the user is logged in to their user account 160.

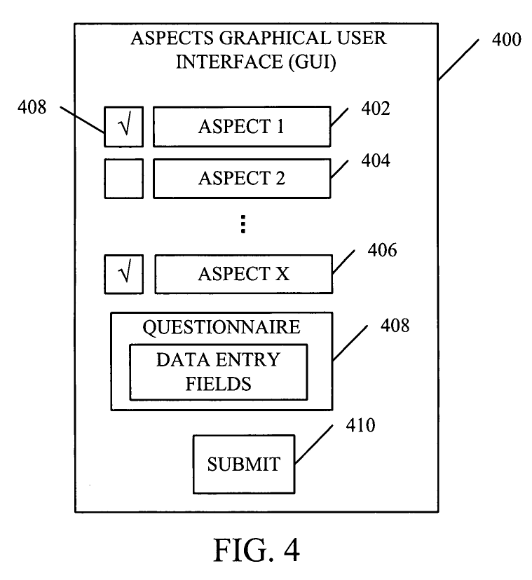

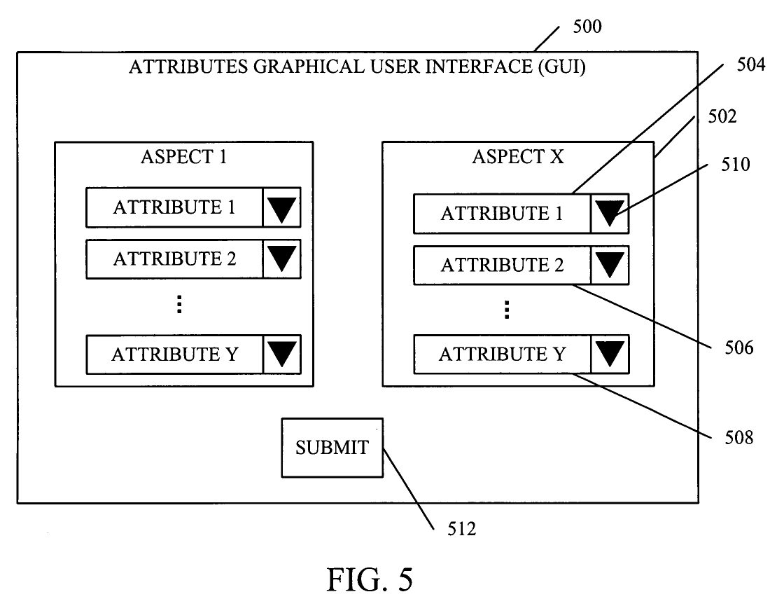

FIG. 2B illustrates a flowchart of a process 220 to generate a user profile in accordance with one embodiment of the present invention. The user profile is used to determine whether a user matches to any one particular Community. When determining a match, the user profile should have all or most of the elements (Aspects/Attributes) of the Community eligibility profile. In general, the Community eligibility profile has a limited set of elements (Aspects/Attributes) when compared to the full set of elements (Aspects/Attributes) that may be associated with the user in their user profile. Thus, when determining whether a match is found, the match criteria may be whether the user profile has elements that meet the Community eligibility profile. FIG. 2B will be described in relation to FIGS. 4 and 5. FIG. 4 illustrates an Aspects GUI 400 for use by the user. The process 220 begins with block 222 where a display of aspects 402, 404, and 406 are automatically displayed, such as shown in FIG. 4. At block 224, the user's selection from the list is received. In one configuration, the Aspect GUI 400 includes a plurality of Aspects 1-X each associated with a different Aspect field 402, 404, 406. A check box 408 is associated with each of the Aspect fields 402, 404, and 406. A check may appear upon selection of a respective one check box 408 with a click of a mouse, designated key or the like. In another configuration, after the user has selected the appropriate Aspects, the submit button 410 may be selected. As can be appreciated, in lieu of a check box, another type of radial button may be used and selected with a click of a mouse. At block 226, a list of Attributes associated with one or more selected Aspects is displayed to the user.

Aspects related to things a user has associationship with may be entered in data entry fields 408. For example, the user may be provided a questionnaire to fill-in various information related to the user without the need for the user to select a particular Aspect. The examples, set forth are for illustrative purposes. Other means of collecting personal information and user associationship information from a user on-line via the website system 120 may be used.

FIG. 5 illustrates an Attributes graphical user interface (GUI) 500 to enter Attributes associated with a user selected Aspect. For sake of example, the user selected Aspect 1, denoted by Aspect field 402, and Aspect X, denoted by Aspect field 406. The associated check box 408 is shown selected and the check appears. Returning again to FIG. 2B, at block 228, Attributes are selected for one or more selected Aspects. At block 230, the web server 125 stores the Aspects and related Attributes for the user in a user profile database 162. The information entered related to personal information and user associationship information is also stored in the user profile database 162.

Returning again to FIG. 5, each Aspect includes a plurality of Attributes denoted by Attribute fields 504, 506 and 508. Each of the Attributes may have one or more Attribute value possibilities from which to select via a drop down list by selecting icon 510 or some other designated icon. The list of Attribute value possibilities may be selected in a variety of other ways. For the sake of explaining the process let us assume that a user selected an Aspect pertains to ‘Auto’ in FIG. 4. The associated Attributes 1-Y may included Make, Model, Trim, Color, value in dollars, Vehicle Identification Number, Registration Plate, the acquired date, etc. Each attribute may have a list of Attribute value possibilities from which the user may select. Alternately, in lieu of providing the user with a list of Attribute values, a data entry field may be provided so that the user may manually enter in the Make of their automobile. For example, for the Make Attribute, a website system 120 may provide a set of Attribute values from which to select an Attribute value and may include a list for foreign and domestic car manufactures.

Some of the Attributes may be configured to be optional and some others may be configured to be required. All required attributes need to be filled by the user while the optional attributes may not be filled by the user. The user responds by giving proper Attribute values to the Attributes of an Aspect. After completing the entry or selection of the Attributes, the user may then select a Submit button 512. Thereafter, the web server 125 then adds the Aspect/Attribute values to the user's profile 162. The Attributes GUI 500 is shown with an area for Aspect 1 beside and an area for Aspect X. Nonetheless, the areas for Aspect X may be found below Aspect 1. Likewise for the arrangement of Attributes 1-Y may be arranged serially in a horizontal plane or other arrangements suitable to present information to the user.

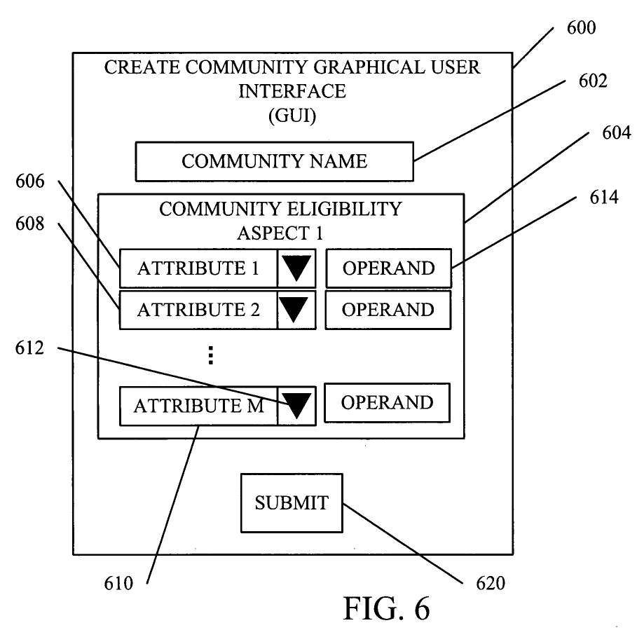

FIG. 2C illustrates a flowchart of a process 250 to create a new Community. FIG. 2C will be described in relation to FIG. 6 which illustrates a Create Community graphical user interface (GUI) 600 to create a Community. The process 250 begins at block 252 (after the user selects to create a new Community at block 212 of FIG. 2A). At block 252, the user gives a name to the Community by entering a Community Name in the Community Name field 602. At block 254 the user defines the eligibility criteria that prospective members should match. Only the users who match or meet the eligibility criteria may be able to find and join the Community. Eligibility criteria may include, but not limited to, number of a specific type of Aspects, such as community eligibility Aspect 1 denoted at 604, members should possess and/or what values should some Aspect Attributes 606, 608 and 610 have. Each Attribute 606, 608 and 610 has associated therewith an Operand 614. For example, a user wishing to create a Community called ‘Acura owners in San Jose’ to create a community for all Acura auto owners living in San Jose may define the following as the eligibility criteria for that community. ‘Make’ attribute of a User's ‘Auto’ aspect should be equal to ‘Acura’ and ‘City’ attribute of a User's ‘Home’ aspect should be equal to ‘San Jose’. This example, is provided to illustrate the concept very succinctly. A more complicated eligibility criteria could be for individuals (users) born in China, with a degree from Stanford university, who currently work or worked in Microsoft, and living in Ohio state, and who have at least two kids. Thus, a value ‘Country’ of Attribute of a User's ‘Place of Birth’ Aspect should be equal to ‘China’ and ‘School Name’ Attribute of a User's ‘College’ Aspect should be equal to ‘Stanford’ and ‘Name’ Attribute of a User's ‘Employer’ aspect should be equal to ‘Microsoft’ and ‘State’ attribute of a User's ‘Home’ aspect should be equal to ‘Ohio’ and Number of User's ‘Son’ or ‘Daughter’ aspects is greater than or equal to ‘2’. The Operand 614 may have an ‘equal to’ and ‘greater than’ entered in the field. Alternately, a selection may be presented to the user. Even a radial button may be used to select from a set of permitted Operands. While there are Attributes 1-M, some of the Attributes may need to be selectively omitted or a value not provided.

While the Create Community GUI 600 only illustrates one Community Eligibility Aspect, the Create Community GUI 600 may include a plurality of Aspects below Aspect 1 or beside Aspect 1.

After the Community eligibility criteria have been defined, the user may submit the criteria using a Submit button 620. At block 254, a check is made to ensure that the creating user matches the criteria in this embodiment. In another configuration, block 256 may be omitted. However, if the user doesn't pass the eligibility criteria at block 256, the user is provided an operation to change or update their user profile at block 258 to match or meet the Community eligibility profile just entered. Also after block 254, the user may desire to change or update their user profile at block 258 so that their user profile matches the Community eligibility profile. Once the user matches or meets the Community eligibility profile, at block 260, the web server(s) 125 generates a Community file or database 140 that is added to the collective set of Communities database 130. The web server(s) 125 may add the Community name, eligibility profile 142, user name and the other necessary database record identifiers and information to the Community database 140. Furthermore, a list of members 144 as the join may be added and updated.

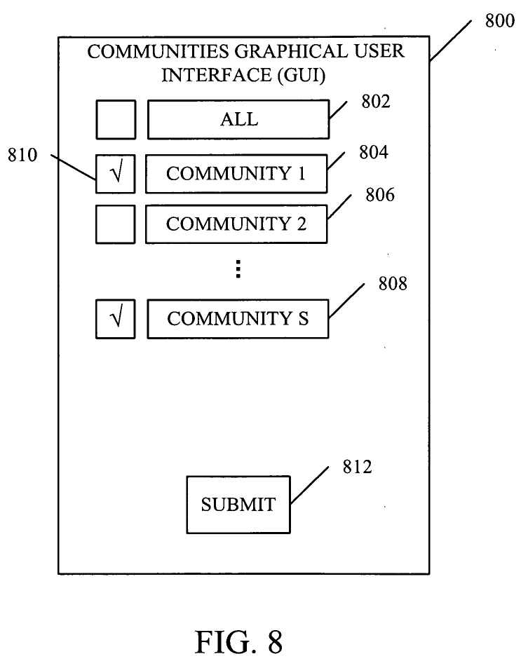

FIG. 2D illustrates a flowchart of the process 280 for matching and selectively linking together users to Communities in accordance with one embodiment of the present invention. FIG. 8 illustrates a Communities graphical user interface (GUI) 800 in accordance with one embodiment of the present invention. The process 280 begins with block 282 where the user is displayed a Communities GUI 800 that lists Communities in the Collective set of Communities database 130 or a subset of Communities based on the user's interests. The Communities GUI 800 includes a display of Communities. The Communities GUI 800 includes a plurality of Communities 1-S each associated with a different Community field 804, 806, 808. A check box 810 is associated with each of the Community fields 804, 806, 808. A check may appear upon selection of a respective one check box 810 with a click of a mouse, designated key or the like. In another configuration, after the user has selected the appropriate Community(s) of Interest, the submit button 812 may be selected. An All field 802 with a check box (or other radial button) may be provided to automatically select all of the Communities.

At block 284, a Communities Matching Process is performed to determine is a user (based on the user profile) matches or meets any of the selected Communities in the collective set of communities in the database 130 or all Communities if the All field 802 is selected by the user. At block 286, if one or more matches are found, the user is displayed or provide a list of matching Communities with an option to join one or more of the matching Communities.

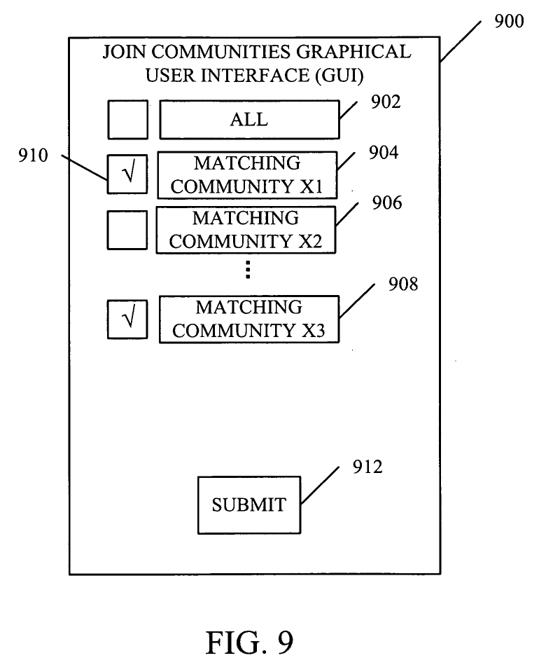

FIG. 9 illustrates a join Communities graphical user interface (GUI) in accordance with one embodiment of the present invention. The join Communities GUI 900 includes the list of matching Communities X1-X3 each associated with a different Community field 904, 906, 908. A check box 910 is associated with each of the Community fields 904, 906, 908. To join any one of the Communities in the list of matching Communities X1-X3, the user selects one or more of the matching Communities by placing a check in respective one or more check boxes 910 with a click of a mouse, designated key or the like. In another configuration, after the user has selected the appropriate Community(s) to join, the submit button 912 may be selected. An All field 902 with a check box (or other radial button) may be provided to automatically select all Communities in the list of matching Communities X1-X3 to join.

At block 288, the user may join a Community that the user matches. Thus, at block 288, the user enters a selection to join a Community in the list of one or more matching Communities. At block 290, the web server(s) 125 links the user account 160 and user to the selected matching Community. Furthermore, the web server(s) 125 stores the joined Communities in the joined Communities database 164. Moreover, the member file or database 144 may be updated for the Community.

As Communities are added by other users, the website system 120 may automatically conduct a Community matching process with one or more of the user accounts 150, and notify the matched users of the one or more matching Communities.

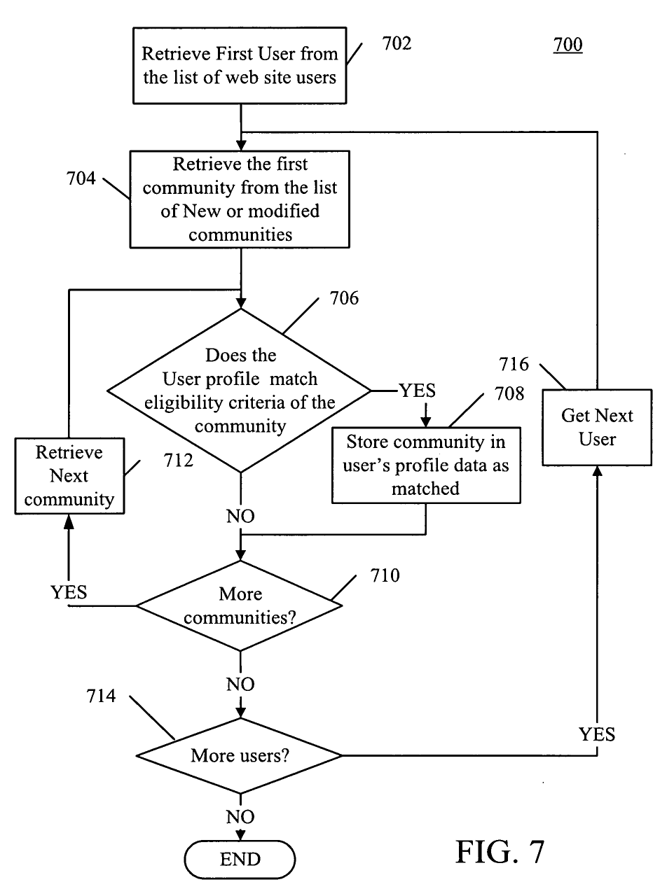

FIG. 7 illustrates a flowchart of a process 700 to match users to Communities in accordance with one embodiment of the present invention. The process 700 begins at block 702 where a first user profile from a list of the user accounts 150 is retrieved. At block 704, a first Community from the collective set of Communities database 130 is retrieved. At block 706, a comparison of the user profile to the Community eligibility profile is conducted. If the user profile contains elements that meet the Community eligibility profile then a match is found between the user and Community. If the determination at block 706 is “YES,” then block 706 is followed by block 708 where the user account 160 for a particular user is notified and the match is logged as a Community match in the user account 140. Block 708 is followed by block 710. Furthermore, if the determination at block 706 is “NO,” then block 706 is followed by block 710. At 710 block a determination is made whether there are any more Communities. If the determination at block 710 is “YES,” then block 710 is followed by block 712 where the next community is retrieved. Block 712 loops back to block 706.

If the determination at block 710 is “NO,” then block 710 is followed by block 714 where a determination is made whether there are more users. If the determination at block 714 is “YES,” then block 7146 is followed by block 716 where the next user account is obtained. Block 716 loops back to block 704 to repeat the process.

If the determination at block 714 is “NO,” then the process 700 ends. The user accounts are updated with a list of matched Communities from which the user may selectively join. As the user's join matched Communities, the user's joined Communities are maintained in the joined Communities database 164. Furthermore, the member database 144 for a Community is updated with pertinent user information.

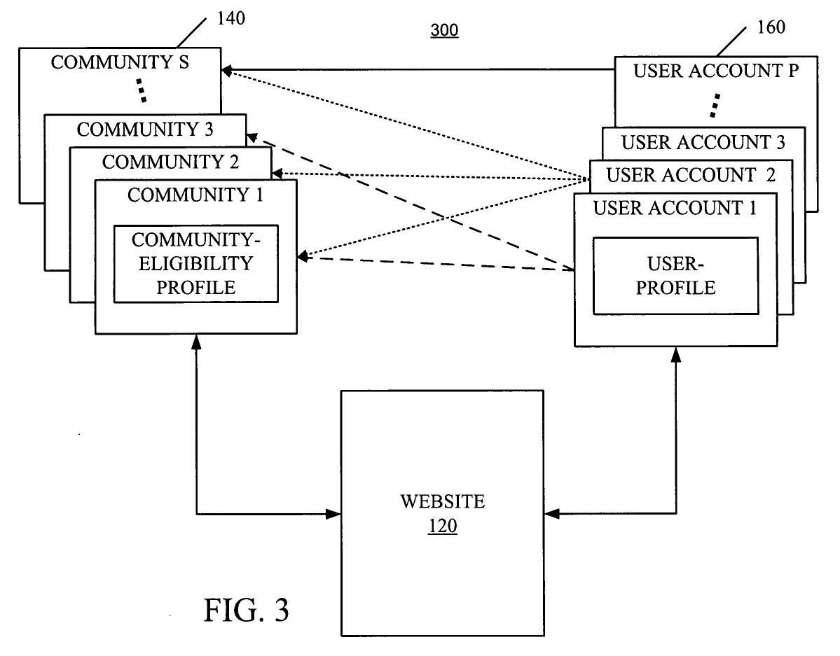

FIG. 3 illustrates a block diagram of linked users and Communities in accordance with one embodiment of the present invention. Website 120 links the user accounts 160 to one or more Communities 140 such as when they are joined. The user account 160 is updated with joined Communities in the database 164.

It should be understood that the graphical user interfaces (GUI) are for illustrative purposes only. Furthermore, one or more the GUIs may be combined with another GUI. Furthermore, the means for collecting information using the GUI is only one example of collecting information.

It will be understood that each block of the flowchart illustrations discussed above, and combinations of blocks in the flowchart illustrations above, can be implemented by computer program instructions. These program instructions may be provided to a processor to produce a machine, such that the instructions, which execute on the processor, create means for implementing the actions specified in the flowchart block or blocks. The computer program instructions may be executed by processor to cause a series of operation steps to be performed by the processor to produce a computer-implemented process such that the instructions, which execute on the processor, provide steps for implementing the actions specified in the flow chart block or blocks.

Accordingly, blocks of the flowchart illustration support combinations of means for performing the specified actions, combinations of steps for performing the specified action and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The operations described above may be implemented in hardware, software, firmware, or a combination thereof. Software may include one or more instructions or code on a computer-readable medium. Computer-readable media may include computer storage media (such as, without limitation, RAM, ROM, EEPROM, CD-ROM) and/or communication media. A storage media may be any available media that can be accessed by a computer.

The previous description of the present invention is provided to enable a person skilled in the art to make or use the invention. Various modifications to these configurations will be readily apparent to those skilled in the art, and the principles defined herein may be applied to other configurations without departing from the spirit or scope of the disclosure. Thus, the disclosure is not intended to be limited to the embodiments shown but is to be accorded the broadest scope consistent with the principles and features disclosed herein above.

What is claimed is:

1. A system comprising:
at least one server operable to establish a community eligibility profile for one or more Communities and receive a user profile from each user;
at least one database coupled to the at least one server to store a Community eligibility profile for the one or more Communities and the user profile of one or more users; and
the at least one server is further operable to determine which of the user profiles meet the Community eligibility profile of one or more Communities and to notify the one or more users of any matched Communities with an option to join any of the matched Communities.

2. The system according to claim 1, wherein the at least one server is further operable to managing a user account for each user, the user account for each user includes the user profile.

3. The system according to claim 2, wherein the at least one server is further operable track those Communities created by a specific user and joined Communities by the specific user.

4. The system according to claim 2, wherein the at least one server is further operable to receive information related to associationship of the specific user for the user profile related to the specific user.

5. The system according to claim 4, wherein the at least one server is further operable to receive associationship information for a new Community by the specific user wherein the Community eligibility profile is based on the associationship information for the new Community.

6. The system according to claim 5, wherein the at least one server is further operable to determine whether the user profile of the specific user creating the new Community meets the Community eligibility profile entered; and to provide the specific user an option to change their user profile, if their user profile does not provide a match.

7. A computer program product including a computer readable medium having instructions for causing a computer to:
receive a user profile from each user;
receive a user generated community eligibility profile for a Community;
store the Community eligibility profile for one or more Communities;
store the user profile of one or more users;
determine which of the user profiles meet the Community eligibility profile of one or more Communities; and
notify the one or more users of any matched Communities with an option to join any of the matched Communities.

8. The computer program product according to claim 7, further comprising instructions for causing the computer to manage a user account for each user, the user account for each user includes the user profile.

9. The computer program product according to claim 8, further comprising instructions for causing the computer to track those Communities created by a specific user and joined Communities by the specific user.

10. The computer program product according to claim 8, wherein the instructions to receive the user profile includes instructions to receive information related to associationship of the specific user for the user profile related to the specific user.

11. The computer program product according to claim 10, wherein the instructions to receive the user generated community eligibility profile includes instructions to receive associationship information for a new Community by the specific user wherein the Community eligibility profile is based on the associationship information for the new Community.

12. The computer program product according to claim 11, further comprising instructions for causing the computer to determine whether the user profile of the specific user creating the new Community meets the Community eligibility profile entered; and to provide the specific user an option to change their user profile, if their user profile does not provide a match.

13. A method comprising:
receiving a user profile from each user;
receiving a user generated community eligibility profile for a Community;
storing the Community eligibility profile for one or more Communities;
storing the user profile of one or more users;
determining which of the user profiles meet the Community eligibility profile of one or more Communities; and
notifying the one or more users of any matched Communities with an option to join any of the matched Communities.

14. The method according to claim 13, further comprising managing a user account for each user, the user account for each user includes the user profile.

15. The method according to claim 14, further comprising tracking those Communities created by a specific user and joined Communities by the specific user.

16. The method according to claim 14, wherein the receiving of the user profile includes receiving information related to associationship of the specific user for the user profile related to the specific user.

17. The method according to claim 16, wherein the receiving the user generated community eligibility profile includes receiving associationship information for a new Community by the specific user wherein the Community eligibility profile is based on the associationship information for the new Community.

18. The method according to claim 17, further comprising determining whether the user profile of the specific user creating the new Community meets the Community eligibility profile entered; and providing the specific user an option to change their user profile, if their user profile does not provide a match.
